(19) United States
(12) Patent Application Publication
(10) Pub. No.: US 2009/0238993 A1
(43) Pub. Date: Sep. 24, 2009

(54) Surface preheating treatment of plastics substrate

(75) Inventors: Michael W. Stowell, Loveland, CO (US); Nety Krishna, Sunnyvale, CO (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/077,375

(22) Filed: Mar. 19, 2008

(51) Int. Cl. B05D 3/06

(52) U.S. Cl. 427/553

(57) ABSTRACT

A source of IR radiation is used to heat a plastic substrate in a fast fashion inside a processing chamber, where the processing chamber is configured to preheat the plastic substrate and to perform thin film deposition, such as chemical vapor deposition (CVD) or physical vapor deposition (PVD), or plasma etching and cleaning. One aspect of using the source of IR radiation is to preheat only the surface of the plastic substrate while the core of the plastic substrate remains substantially unheated, so that the structure of the plastic substrate may remain unchanged. Meanwhile, the surface properties of the plastic substrate may be modified after the preheating treatment. The source of IR radiation may be provided at wavelength selected to substantially match the absorption wavelength of the plastic substrate. The plastic substrate moves through the heat flux zone generated by the source of IR radiation at a controllable speed.

### BACKGROUND OF THE INVENTION

Substrate preheating treatment can be achieved by utilizing many techniques and heater arrangements. It is common to heat the substrate by a direct heater such as a resistor heating plate in thin film deposition processes, such as physical vapor deposition (PVD) or chemical vapor deposition (CVD) process. By using a direct heating plate, the substrate temperature may be heated up to approximately 700° C. With microwave-assisted CVD or PVD processes, the substrate temperature may be lowered to below 200° C. In the case of lower substrate temperature, indirect heating sources may be used, such as a resistor heating source, a lamp, or a flash heater. Flash heaters have been developed to significantly reduce cycle times and increase productivity in rapid thermal processing. Flash heaters are used in many applications, such as repairing damage and annealing surface and so on.

One of the challenges in thin film deposition on plastic substrates is the difficulty in maintaining structural integrity of plastic substrates. Plastics have a much lower softening temperature, such as melting point or glass transition temperature, than glasses or ceramics. When a plastic substrate is heated near the softening temperature prior to thin film deposition or etching, the plastic substrate often reaches the melting point or glass transition temperature with the additional heat generated from the thin film deposition process. Therefore, the plastic substrate may experience structural distortion as a result of overheating during the thin film deposition or etching process.

An advanced pulsing technique has recently been introduced in modulating the power of a plasma source, such as a microwave ion source, to reduce the thermal load generated from thin film deposition processing. This technique is useful in depositing coatings on a plastic substrate.

There still remains a need for modifying the surface properties of a plastic substrate while the plastic substrate remains structural integrity. The modification may be through thin film deposition, plasma etching, or plasma cleaning process.

### BRIEF SUMMARY OF THE INVENTION

Embodiments of the invention use a source of IR radiation such as an infrared heater to heat a plastic substrate in a fast fashion in a processing chamber, where the processing chamber is configured to preheat the plastic substrate and to perform thin film deposition, such as chemical vapor deposition (CVD) or physical vapor deposition (PVD), or plasma etching and cleaning. One advantage of using the source of IR radiation is to preheat only the surface of the plastic substrate while the core of the plastic substrate remains substantially unheated, so that the structure of the plastic substrate may remain unchanged. Meanwhile, the surface properties of the plastic substrate may be modified after the preheating treatment. Embodiments of the present invention use the source of IR radiation at a selected wavelength that substantially matches the absorption wavelength of the plastic substrate. This way can optimize the energy absorption of the surface of the plastic substrate. Another aspect of the fast preheating treatment of the present invention is that the source of IR radiation is powered on continuously while the plastic substrate moves through the heat flux zone generated by the source of IR radiation at a controllable speed. Such a preheating treatment allows the plastic substrate to be heated substantially uniform in a few seconds. The plastic substrate may be preheated near a critical temperature that allows a change in surface morphology or surface structure to occur.

In one set of embodiments of the invention, the source of IR radiation may have a variable infrared wavelength for energy irradiation. A plastic substrate absorbs energy in a range of wavelengths. The peak absorption wavelength depends upon the molecular structure of a plastic substrate. Each plastic has a unique spectrum of energy absorption. By selecting a wavelength of the source of IR radiation to substantially match with the characteristic absorption spectrum of the plastic substrate, the energy absorption on the surface of the plastic substrate is enhanced. Therefore, the differential temperature between the surface of the plastic substrate and the core of the plastic substrate increases significantly by selecting the wavelength of the source of IR radiation, when compared to a conventional preheating treatment. The source of IR radiation may have peak wavelengths ranging from 1.5 μm to 3 μm for substantially maximum heat absorption of the plastic substrate.

In another set of embodiments of the invention, the plastic substrate is configured to move at a relatively fast speed, for example, ranging from 1 m/min to 30 m/min, to allow substantially uniform surface heating in a fast fashion, for example, within a few seconds. By using the fast preheating treatment with the selected wavelength for energy absorption and a relatively fast movement of the plastic substrate relative to the source of IR radiation, about 95% of the heat is absorbed on the surface of the plastic substrate in a specific embodiment of the invention, the surface having a skin depth less than 25% of the thickness of the plastic substrate such as polycarbonate. The skin depth is controlled by varying the speed of the substrate movement, or the wavelength and power of the source of IR radiation, depending upon specific requirements of a particular application. The thickness of the plastic substrate generally exceeds 4 mm and is relatively thick, when compared to Mylar film.

In a different set of embodiments of the invention, the entire plastic substrate may be preheated by a heater to an elevated temperature to meet specific requirements. The source of IR radiation is then used to further preheat the plastic substrate in a fast fashion, when the plastic substrate moves through the heat flux zone that is generated by the source of IR radiation at a controlled speed. This preheating by using the source of IR radiation mostly heats the surface of the plastic substrate so that the core of the plastic substrate remains relatively cold. The heater for preheating the entire plastic substrate comprises a resistor heating plate, a lamp or a flash heater.

Embodiments of the invention further include a single side preheating treatment and a double side preheating treatment. In the specific embodiment of the single side preheating treatment, a source of IR radiation is located on only one side of the plastic substrate. In the alternative embodiment of the double side preheating treatment, each side of the plastic substrate has a source of IR radiation for the preheating treatment. The position of the source of IR radiation relative to the plastic substrate is adjustable. When the source of IR radiation is closer to the plastic substrate, the preheating time required to achieve certain surface temperature is generally shorter than when the source of IR radiation is away from the plastic substrate.

In alternative embodiment, the plastic substrate may be preheated by another heat source before moving into the processing chamber. This preheating is different from the fast preheating treatment for the surface, because the entire substrate is preheated to an elevated temperature. The heat source may be an indirect source, among others, such as a resistor heater a lamp, or flash heater.

The present invention may be utilized in automotive industry, such as modifying surface properties for polycarbonate windows, plastic sunroof, and the like. The invention may also be used for depositing coatings under vacuum or atmospheric conditions, and etching surface treatments. Furthermore, the present invention may be used along with microwave assisted thin film deposition process such as physical vapor deposition (PVD) or chemical vapor deposition (CVD), where a coaxial linear plasma source or an array of coaxial plasma line sources may be used to assist the PVD or CVD for enhancing plasma density and increasing deposition rate. For example, the present invention may be used with plasma systems like the ones described in several related patent applications: U.S. patent application Ser. No. ______, entitled “Index Modified Coating on Polymer Substrate,” filed by Michael W. Stowell and Manuel D. Campo (Attorney Docket No. A11896/T083800); U.S. patent application Ser. No. ______, entitled “Coaxial Microwave Assisted Deposition and Etch System,” filed by Michael W. Stowell, Net Krishna, Ralf Hofman, and Joe Griffith (Attorney Docket No. A12659/T83600); U.S. patent application Ser. No. ______, entitled “Microwave Rotatable Sputtering Deposition,” filed by Michael W. Stowell, Net Krishna (Attorney Docket No. A012144/T82800); U.S. patent application Ser. No. ______, entitled “Microstrip Antenna Assisted IPVD,” filed by Michael W. Stowell and Richard Newcomb (Attorney Docket No. A011899/T082700); U.S. patent application Ser. No. ______, entitled “Microwave-Assisted Rotatable PVD,” filed by Michael W. Stowell, Net Krishna (Attorney Docket No. A012151/T86000); and U.S. patent application Ser. No. ______, entitled “Microwave Plasma Containment Shielding,” filed by Michael W. Stowell (Attorney Docket No. A011869/T082600). The entire contents of each of the above patent applications are incorporated herein by reference for all purposes

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings.

### BRIEF DESCRIPTION OF THE DRAWINGS

The file of this patent contains at least one drawing executed in color. Copies of this patent with color drawings will be provided by the Patent and Trademark Office upon request and payment of the necessary fee.

FIG. 1 shows an absorption spectrum for polycarbonate with a thickness of 1.0 mm and 4.8 mm.

FIG. 2 shows the emission spectrum of an infrared heater.

FIG. 3A shows a simplified single side preheating system that uses a source of IR radiation with variable wavelengths.

FIG. 3B shows a simplified double side preheating system that uses a source of IR radiation with variable wavelengths.

FIG. 4 shows a flow chart illustrating steps of preheating the surface of a plastic substrate.

FIG. 5A (in color) shows a result of modeling the temperature distribution for heating a polycarbonate substrate at a selected wavelength after 3 seconds of heating.

FIG. 5B shows a result of modeling the temperature distribution for transient temperature on the top and bottom surfaces of a polycarbonate substrate with heating at a selected wavelength.

FIG. 6A (in color) shows a result of modeling the temperature distribution for a conventional heating with short wavelength (curve 204 in FIG. 2).

FIG. 6B shows a result for modeling the transient temperature on the top and bottom surfaces of a polycarbonate substrate for a conventional heating with short wavelength (curve 204 shown in FIG. 2).

FIG. 6C shows experimental results for a polycarbonate substrate for a conventional heating with short wavelength (curve 204 shown in FIG. 2).

FIG. 7 shows the water absorption spectrum.

### DETAILED DESCRIPTION OF THE INVENTION

### 1. Energy Absorption Spectrum of a Plastic

Fourier Transform Infrared (FTIR) spectroscopy is used in the identification of various unknown organic materials such as plastics, adhesives, lubricants, and bearing greases. FTIR works by exciting chemical bonds with infrared light. Different chemical bonds absorb light energy at unique frequencies. This activity is represented as a spectrum of the material. The spectrum is essentially a “fingerprint” of the compound that can be used to search against reference spectra from libraries for the purpose of identification. A ratio of the specific peak heights can sometimes be used to quantify proportions in simple mixtures, degree of oxidization or decomposition, purity, etc. The FTIR aids in identifying chemical bonds, and the chemical composition of materials. Each peak in the FTIR spectrum is associated with a functional group or a chemical bond, depending upon the molecular structure of a plastic or an organic compound.

In embodiments of the present invention, the absorption spectra are used for a different purpose than commonly used for the purpose of identification. Instead of using the “fingerprint” to distinguish organic materials, the wavelength range for the majority of large peaks in energy absorption of a plastic is used to assist in selecting wavelength of a source of IR radiation such as an infrared heater to substantially match with the peak energy absorption. In a specific embodiment of the invention, the energy absorbed on the surface of a plastic substrate such as polycarbonate is approximately 95% by selecting the wavelength of the source of IR radiation to match with the absorption peaks of the plastic substrate, with the surface skin depth being less than 25% of the thickness of a plastic substrate. Therefore, the surface temperature may reach 200° C. or below in some embodiments, while the center of the plastic substrate still remains near the ambient temperature. The feature of such a large differential temperature between the surface and center of a plastic substrate enables surface modification without losing the structural integrity of a plastic substrate during thin film deposition process, for example, among others, physical vapor deposition (PVD) or chemical vapor deposition (CVD), plasma etching, plasma cleaning, and the like.

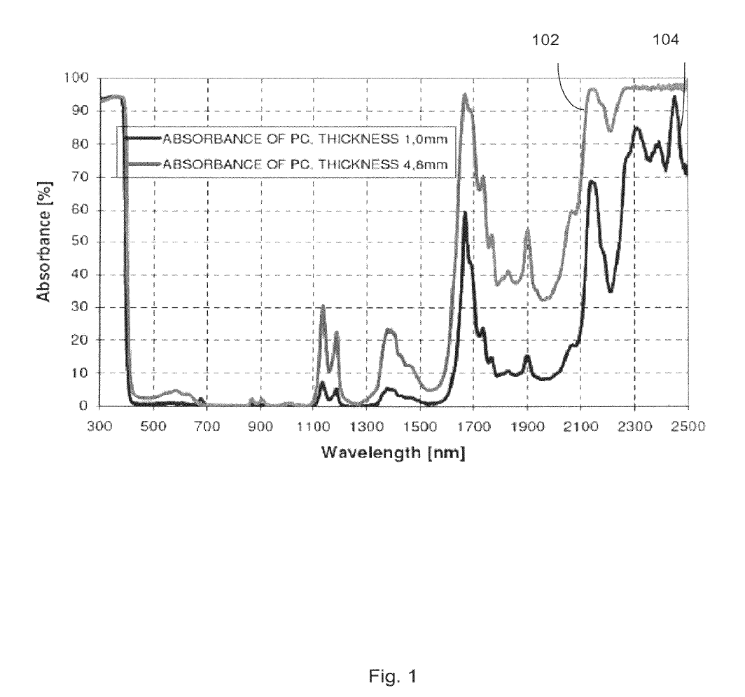

FIG. 1 shows the FTIR absorption spectra for polycarbonate at two different thicknesses, 1.0 mm and 4.8 mm. Note that there are large absorption peaks with wavelengths between 1600 nm and 2500 nm. Spectra 102 and 104 are for thinner and thicker polycarbonate films, respectively. As the sample gets thicker in FTIR analysis, the absorption starts to saturate as shown in spectrum 104 between wavelengths of 2200 nm and 2500 nm. Also, spectrum 104 shows higher peaks than spectrum 102, as the thickness increases. This suggests that the absorption becomes stronger with the thicker plastic substrate.

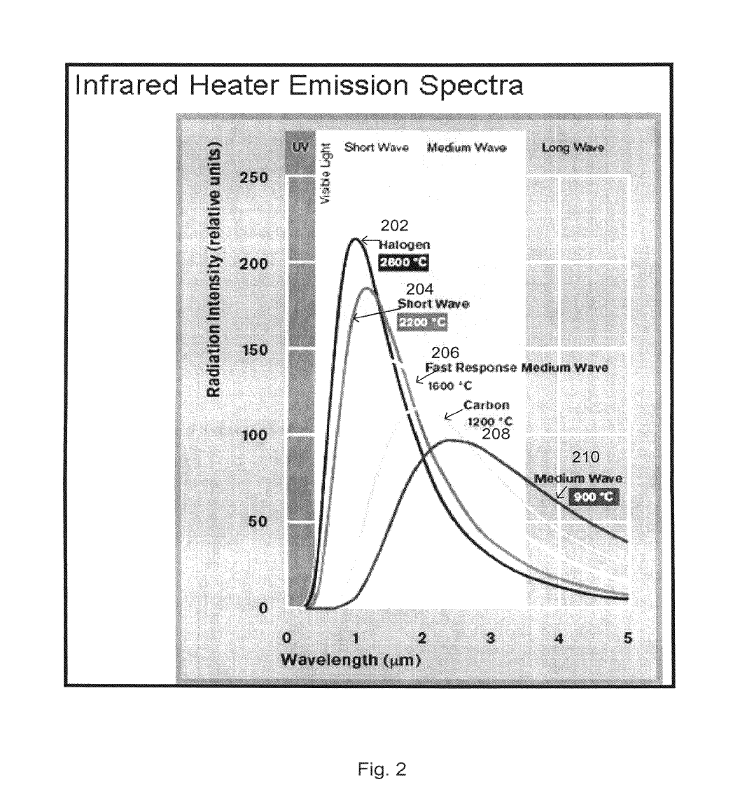

Embodiments of the present invention include any source of IR radiation having a variable wavelength ranging from 0.75 μm to 1 mm. For illustration purpose, FIG. 2 shows the emission spectra for an infrared heater. Note that the infrared heater has five selections of wavelength, such as short wavelengths (e.g. Halogen 202 with peak wavelength around 1 μm and short wave 204 with peak wavelength at about 1.25 μm), and medium wavelengths (e.g. fast response medium wave 206 with peak wavelength at approximately 1.5 μm, carbon 208 with peak wavelength near 2 μm, and medium wave 210 with peak wavelength around 2.5 μm).

### 2. Exemplary Preheating System

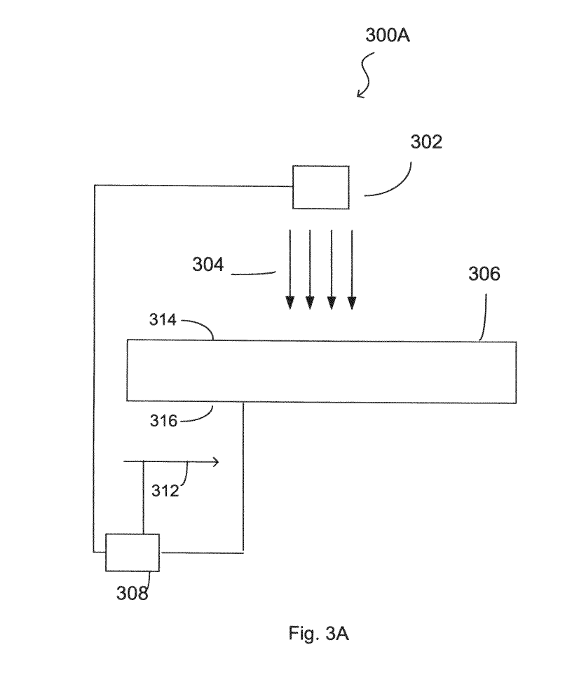

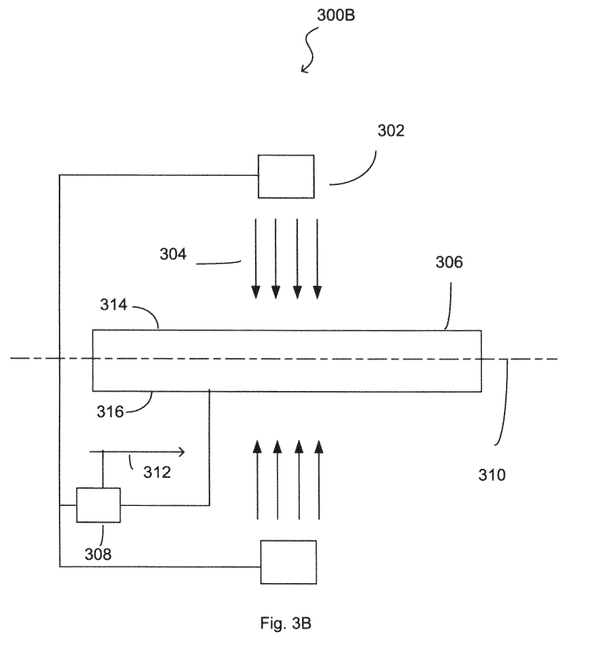

FIG. 3A illustrates a simplified single side preheating system 300A for surface treatment of a plastic substrate. The system 300A comprises a source of IR radiation 302, a substrate, a control box 308, and a substrate supporting member (not shown). The control box 308 controls the movement of the plastic substrate 306 through the heat flux zones 304 along direction 312. The control box 308 also selects the power-on time and wavelength for the source of IR radiation 302. The plastic substrate 306 is configured to move at a relatively fast speed ranging from 1 m/min and 30 m/min. The source of IR radiation 302 has a variable power density and a variable wavelength, for example, it may provide five different wavelengths with peak values around 1 μm, 1.25 μm, 1.5 μm, 2 μm and 2.5 μm as shown in FIG. 2. As a result of surface heating, the top surface 314 may have a significantly higher temperature than that of the bottom surface 316.

FIG. 3B illustrates a simplified double side preheating system 300B for surface treatment of a plastic substrate. The system 300B comprises two sources of IR radiation 302, a plastic substrate, a control box 308, and a substrate supporting member (not shown). The sources of IR radiation 302 are symmetrically positioned around the centerline 310 of the plastic substrate 306. Again, the control box 308 controls the movement of the plastic substrate 306 through the heat flux zones 304 along direction 312. The control box 308 also selects the power-on time and wavelength for the source of IR radiation 302. The plastic substrate 306 is configured to move at a relatively fast speed ranging from 1 m/min and 30 m/min. The source of IR radiation 302 has a variable power density and a variable wavelength, for example, it may provide five different wavelengths with peak values around 1 μm, 1.25 μm, 1.5 μm, 2 μm, and 2.5 μm as shown in FIG. 2. As a result of surface heating, the top surface 314 and the bottom surface 316 have significantly higher temperatures than that of the centerline 310.

In a specific embodiment of the present invention, a plastic substrate is entirely preheated by a different heat source from the source of IR radiation to an elevated temperature (not shown in FIGS. 3A and 3B). The heat source may be an indirect source, such as a resistor heating source or a lamp. The preheated substrate is further heated by the source of IR radiation.

In another embodiment of the present invention, a substrate supporting member may be adopted to the single side or double side preheating systems to allow quick movement of the plastic substrate without obstructing the substrate surface to receive the heat flux from the sources of IR radiation.

### 3. Exemplary Pretreament Process

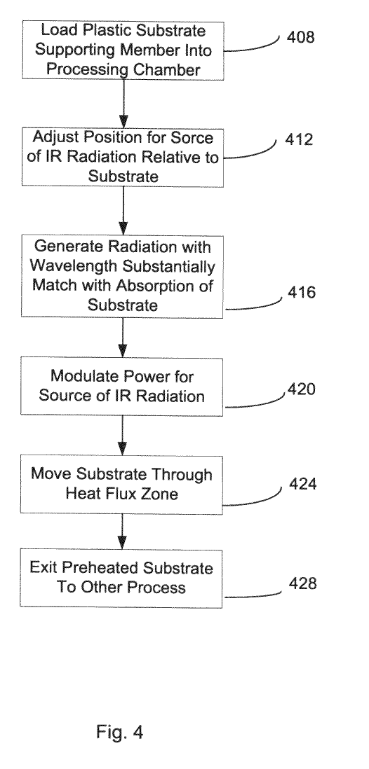

For purpose of illustration, FIG. 4 provides a flow diagram of a process that may be used for preheating of a plastic substrate. The process begins with loading a substrate supporting member into a processing chamber at block 408. The substrate supporting member is configured to support a substrate and allow the substrate to move quickly, so that the substrate is allowed to heat uniformly across the surface of the plastic substrate. The substrate may move at a speed between 1 m/min and 30 m/min along the substrate supporting member. With such a speed, the substrate may be heated in a short time while the source of IR radiation is powered on continuously. This preheating method is different from a conventional flash heating when the source of IR radiation is powered on and off, while the substrate does not move relative to the source of IR radiation.

The position of the source of IR radiation relative to the substrate supporting member is adjusted at block 412. The heat radiation into the surface of a plastic substrate may be controlled by adjusting the distance between the source of IR radiation and the substrate or substrate supporting member. For example, when the source of IR radiation is closer to the substrate, a substrate may get more heat than when it is away from the substrate. This position adjustment helps control preheating of the plastic substrate.

The wavelength of the source of IR radiation is also adjusted at block 416. This is a processing parameter used to control preheating of the plastic substrate. Examples in the following section will show the impact of selecting a wavelength of an infrared heater to substantially match the absorption wavelength of the plastic substrate on the differential temperature between the surface and center of the plastic substrate. With such a selection of wavelength, the differential temperature between the surface and center of the plastic substrate is so large that the surface is able to be heated and modified while the core of the plastic substrate remains cool and keeps the structural integrity of the plastic substrate.

Once the wavelength of the source of IR radiation is selected for the plastic substrate, the source of IR radiation may be turned on at block 420. The source of IR radiation may have a variable power density. Depending upon the preheating requirements, the power density may be adjusted to meet the preheating need.

In a special case of preheating the whole substrate to an elevated temperature, a different heat source may be used for preheating the plastic substrate. This is an optional step (not shown in the flow diagram shown in FIG. 4).

After the source of IR radiation is loaded, positioned, selected for wavelength, powered on and adjusted to a power density, the plastic substrate is ready to move into the processing chamber at block 424. The movement of the plastic substrate along the substrate supporting member is controlled at a variable speed. For example, the movement of the plastic substrate may be slow to start with and then gets faster to pass through the heat flux zone and exit the processing chamber to other processes at block 428.

### 4. Modeling and Experimental Results

A few terminologies are explained here, as they are used in ANSYS simulation. The ANSYS is a commercial software package for simulations by finite element method. The simulations are based upon the theories in, among others, heat transfer and thermodynamics including both steady-state and transient analyses, solid mechanics including both static and dynamic stress analyses, and fluid dynamics etc.

Thermal conductivity is defined from Fourier's law:

qₓ″=k dT/dX

where qₓ″ is the heat flux in the x direction, T is temperature, dT/dX is the temperature gradient in the x direction, and k is the thermal conductivity. The thermal conductivity indicates how efficient a material can transfer heat through the body of the material, and strongly varies with materials, such as plastics, metals, semiconductors, ceramics, glass etc. For instance, plastics normally have lower thermal conductivity than metals, unless the plastics are filled with conductive fillers, such as carbon for the purpose of reducing electric static discharge (ESD). Plastics are often used as thermal insulators. Many glasses and ceramics are also commonly used as thermal insulators, such as alumina (Al₂O₃), SiO₂, and the like. On the other hand, metals, such as copper, aluminum, gold, and silver, and the like, are used as thermal conductors.

Emissivity is defined by the Stefan-Boltzmann law:

q″=εσT⁴

where q″ is the heat flux, E is the emissivity, σ is the Stefan-Boltzmann constant, and T is the temperature of a body. The emissivity ε indicates how efficiently a surface emits heat energy compared to an ideal radiator such as a black body. Emissivity varies significantly with materials, such as metals, plastics, and ceramics. For example, the emissivity of metallic surfaces is generally small, as low as 0.02 for highly polished gold and silver in a specific embodiment. However, the emissivity of non-conductors is comparatively large, generally exceeding 0.6. For instance, carbon or graphites have emissivity in the range of 0.8 and 0.95. The emissivity is also strongly dependent upon wavelength. At some wavelengths, the emissivity is higher that at some other wavelengths.

Specific heat is a measure of the heat energy required to increase the temperature of a unit quantity of a substance by a certain temperature interval. In general, plastics, glass or ceramics have larger specific heat than metals. Thus, it seems to be harder to change the temperature for a plastic, glass, ceramic, brick, concrete than for a metal, when the same amount of heat is absorbed in a material. For instance, copper has specific heat in the range of 350-450 J/kg/K, depending upon purity or alloying composition. However, for polycarbonate, the specific heat is 1300 J/kg/K, which is significantly higher than for copper.

Of course, density is another factor affecting the temperature change of a substrate when heated. The density indicates the mass per unit volume. The higher density the substrate has, the more inertia the substrate has to the temperature change.

In the most general situation, when incident radiation reaches a surface, this radiation may be reflected, absorbed, and transmitted for a semitransparent medium, such as glass or water. Irradiation G is defined as the rate at which radiation of wavelength λ is incident on a surface per unit area of the surface and per unit wavelength interval dλ about λ The total irradiation G (W/m²) encompasses all spectral contributions. From a radiation balance on a semitransparent surface, it follows that

G_{λ}=G_{λ,ref}+G_{λ,abs}+Gλ,tr

where G_{λ,ref} represents the reflected irradiation, G_{λ,abs} represents the absorbed irradiation and G_{λ,tr} represents the transmitted irradiation. Irradiation is also called power density, which may be used in the specification.

From the balance equation above, for a semitransparent substrate, it follows that

ρ+α+τ=1

where ρ is reflectivity, α is absorptivity, and τ is transmissivity. For opaque surfaces, the transmissivity equals to zero. The reflectivity depends upon whether the reflection is a specular reflection such as from a mirror like surface, or a diffuse reflection such as on rough surfaces that may be a reasonable assumption for most engineering applications. In the ideal cases, a surface appears “black” if it absorbs all incident visible radiation, and it is “white” if it reflects this radiation. Both reflectivity and absorptivity are strongly dependent upon wavelength. With the background information provided above, those of the skill in the art can understand the basic concepts in theoretical modeling to simulate the transient temperatures of a plastic substrate when the plastic substrate absorbs the heat flux from a source of IR radiation.

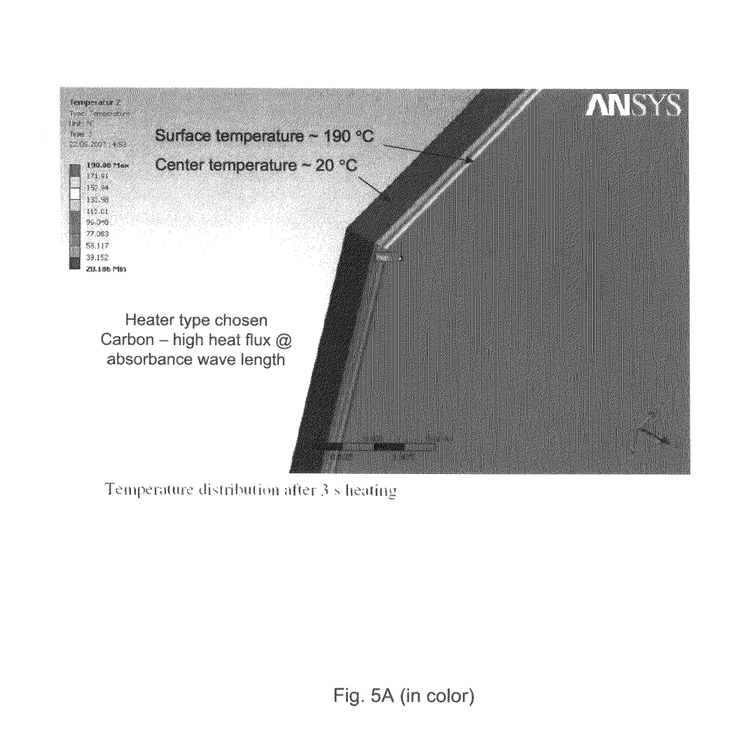

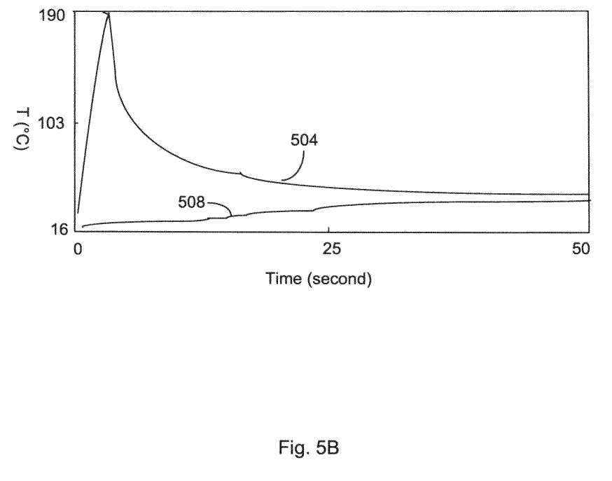

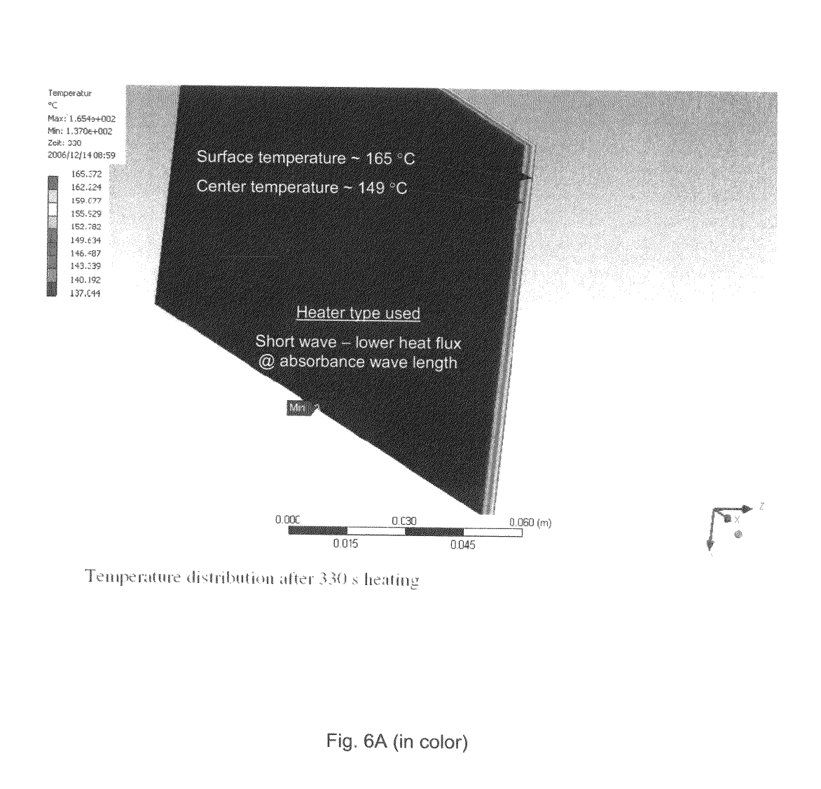

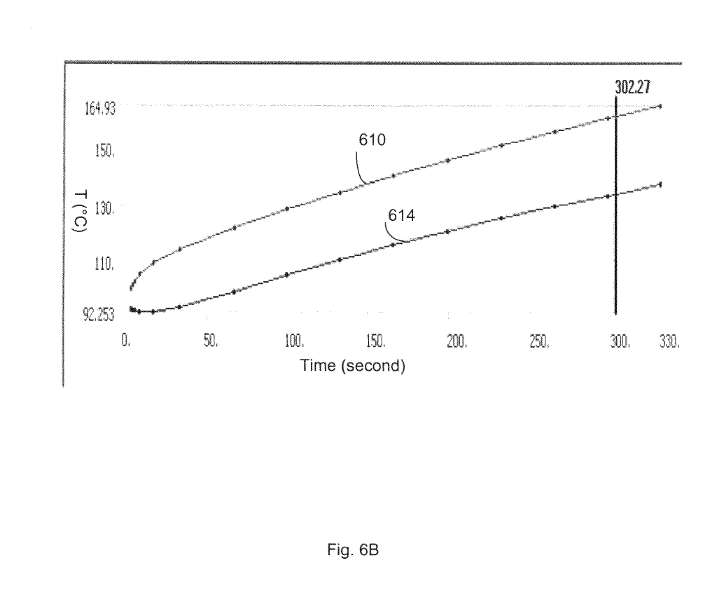

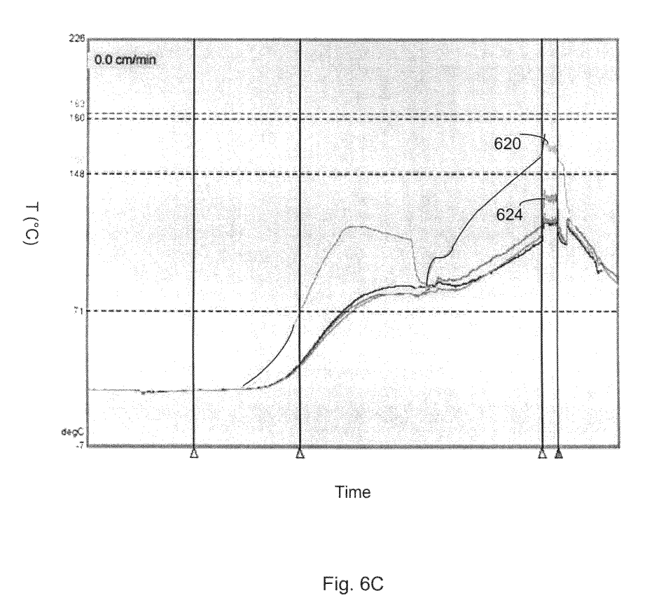

The inventors have performed a number of simulations and experimental tests to verify the large temperature difference between the surface and core of a plastic substrate by using the heating method of the present invention, and to demonstrate the substantial difference between the method of the present invention and the conventional heating method. The results of such simulations or tests are presented below in FIGS. 5A, 5B, 6A, 6B and 6C.

FIG. 5A shows the simulation results for a single side preheating of a plastic substrate from ANSYS. For simulation, a 4 mm thick of polycarbonate (PC) substrate is used. PC has a thermal conductivity of 0.2 W/m/K, a density of 1200 kg/m³, a specific heat of 1300 J/kg/K, an emissivity of 0.9, and a power density of 1800 W/m². The absorbance shown in FIG. 1 for polycarbonate is also used in the ANSYS simulation. As shown in FIG. 5A, when using an infrared heater with selected wavelength (e.g. carbon heater shown in FIG. 2), the surface temperature of the polycarbonate substrate is approximately 190° C. while the center of the polycarbonate substrate is about 20° C. after 3 seconds. This large differential temperature between the surface and center of the plastic substrate allows the surface properties of the plastic substrate to be modified while the plastic substrate remains undistorted under surface heating.

FIG. 5B is a graph to show the transient temperatures for the top and bottom surfaces of the polycarbonate substrate in the same simulations as shown in FIG. 5A. Note that the top surface gets heated up in less than 3 seconds and then gets cooled down, while the bottom surface remains relatively cool during the heating process.

Referring to FIG. 6A now, it shows that with a conventional heater using a short wave (curve 204 shown in FIG. 2) for a single side preheating of the polycarbonate substrate of 4 mm thick, the surface temperature is approximately 165° C., while the center temperature is about 149° C. Therefore, the example demonstrates that under the conventional heating without selecting wavelength to possibly match with the absorption spectrum of the plastic substrate, the center of the plastic substrates gets heated near the softening temperature of the plastic substrate, such as glass transition temperature or melting temperature, so that the plastic substrate may deform or become distorted under heating.

FIG. 6B shows the transient temperatures for the top and bottom surfaces of the polycarbonate substrate, which is preheated from a single side by using a conventional heater without selecting wavelength to possibly match with the absorption spectrum of the plastic substrate. Note that the top surface reaches 165° C. (that is also shown in FIG. 6A), while the bottom surface reaches 137° C. FIG. 6C shows the experimental result for the same polycarbonate substrate. Note that the top surface temperature is about 162° C., while the bottom temperature is roughly 135° C. This example shows that the experimental result is in good agreement with the modeling result shown in FIG. 6B and thus validates the modeling.

The results clearly show a fast preheating treatment for a plastic substrate. The fast preheating method uses a wavelength selection from an infrared heater to possibly match with the absorption peaks of a plastic, which allows substantially higher heat absorption than the conventional heating when the wavelength is not optimized. Furthermore, another aspect of the heating method of the present invention is to move the substrate quickly during preheating while the infrared heater is powered on continuously. This method is different from conventional flash heating, where the infrared heater is powered on and off while the substrate does not move. Such a fast preheating method of the present invention has distinctions from conventional flash heating method. One distinction is to result in larger differential temperature between the surface and the center of the plastic substrate. As a result of the large differential temperature, the surface properties may be modified while the entire structure of the plastic substrate remains intact. The results presented are intended merely to illustrate the effect of the techniques described herein for increasing the differential temperature by providing a relative comparison. The inventors anticipate from these results that for a wide variety of applications, heat absorption may be optimized on the surface in a fast fashion using the techniques described herein.

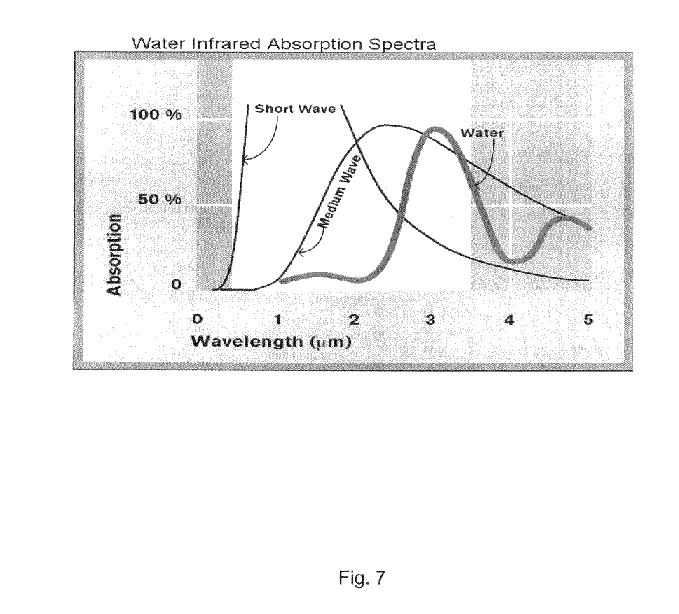

Referring to FIG. 7 now, the absorption spectrum for water is shown. Note that the absorption spectrum of water has a peak near 3 μm, which is different from that of polycarbonate peak absorption ranging from 1.7 μm to 2.5 μm. By using the absorption spectrum of water as a reference in selecting wavelength of a source of IR radiation, the infrared heater may quickly remove moisture from the surface layers of a plastic substrate prior to deposition by using the present invention. Through removing the moisture from the surface of a plastic, the properties of the deposited film may be improved, such as coating adhesion.

Those of ordinary skill in the art will realize that specific parameters can vary for different processing chambers and different processing conditions, without departing from the spirit of the invention. Other variations such as types of source of IR radiation, configuration of the source of IR radiation in the preheating system, method of preheating the substrate prior to fast preheating, ways of moving the substrate along the substrate supporting member, configurations of substrate supporting member to adopt the movement of the substrate in the preheating system, material variations in plastics (thermoplastics, thermosetting, elastomers, etc), will also be apparent to persons of skill in the art. These equivalents and alternative are intended to be included within the scope of the present invention. Therefore, the scope of this invention should not be limited to the embodiments described, but should instead be defined by the following claims.

What is claimed is:

1. A heating method for pretreatment of a plastic substrate, the method comprising:
loading a plastic substrate into a processing chamber;
adjusting a position of a source of IR radiation relative to the plastic substrate;
generating radiation at least one of a plurality of infrared wavelengths with the source of IR radiation, the at least one of the plurality of wavelengths being substantially matched with an infrared wavelength of the plastic substrate for energy absorption;
modulating a power of generated radiation; and
moving the substrate through a heat flux zone defined by the generated radiation at a controllable speed for providing the surface of the plastic substrate to reach a first transient temperature and the center of the plastic substrate to reach a second transient temperature.

2. The heating method for pretreatment of a plastic substrate of claim 1, wherein the plastic substrate comprises polycarbonate.

3. The heating method for pretreatment of a plastic substrate of claim 1, wherein the thickness of the substrate exceeds 4 mm.

4. The heating method for pretreatment of a plastic substrate of claim 1, wherein the energy absorption proximate a top surface of the substrate within a skin depth is greater than 95%.

5. The heating method for pretreatment of a plastic substrate of claim 4, wherein a skin depth of the top surface of the substrate is less than 25% of a thickness of the substrate.

6. The heating method for pretreatment of a plastic substrate of claim 1, wherein the preheating time by using the source of IR radiation is less than 10 seconds.

7. The heating method for pretreatment of a plastic substrate of claim 1, wherein moving the plastic substrate comprises moving at a speed between 1 m/min and 30 m/min.

8. The heating method for pretreatment of a plastic substrate of claim 1, wherein the first transient temperature is substantially higher than the second transient temperature.

9. The heating method for pretreatment of a plastic substrate of claim 8, wherein the first transient temperature is approximately 200° C. at a peak value; and the second transient temperature is below 40° C.

10. The heating method for pretreatment of a plastic substrate of claim 1, wherein the first temperature is approximately equal to a critical temperature for a change in surface morphology or surface structure to occur.

11. The heating method for pretreatment of a plastic substrate of claim 1, wherein the source of IR radiation has wavelength ranging from 0.75 μm to 1 mm.

12. The heating method for pretreatment of a plastic substrate of claim 11, wherein the source of IR radiation has peak wavelengths ranging from 1.5 μm to 3 μm.

13. The heating method for pretreatment of a plastic substrate of claim 1, wherein an entirety of the plastic substrate is preheated to an elevated temperature by a heat source.

14. The heating method for pretreatment of a plastic substrate of claim 13, wherein the heat source comprises an indirect heater.

15. The heating method for pretreatment of a plastic substrate of claim 14, wherein the indirect heater comprises a resistor heating plate or a lamp.

16. The heating method for pretreatment of a plastic substrate of claim 1, wherein radiation generated from the source of IR radiation is incident on a single side of the plastic substrate.

17. The heating method for pretreatment of a plastic substrate of claim 1, wherein radiation generated from the source of IR radiation is incident on a double side of the plastic substrate, the plastic substrate being heated from both the top and bottom surfaces of the plastic substrate.
